(19) United States
(12) Patent Application Publication
(10) Pub. No.: US 2004/0262080 A1
(43) Pub. Date: Dec. 30, 2004

(54) Full body harness for fall arrest utilizing variable-width webbing

(76) Inventors: Richard G. Reynolds, Arvada, CO (US); J. Robert Wagner, Plymouth Meeting, PA (US)

Correspondence Address: James G. Uber, Esq., Mine Safety Appliances Company, P.O. Box 426, Pittsburgh, PA, 15230-0426, US

(21) Appl. No.: 10/863,978

(22) Filed: Jun. 9, 2004

Related U.S. Application Data
(60) Provisional application No. 60/482,309, filed on Jun. 25, 2003.

(51) Int. Cl. A62B 35/00

(52) U.S. Cl. 182/3

(57) ABSTRACT

The present invention provides a full body harness which includes at least one unitary length of webbing woven with a variable width along its length which improves the comfort, use and performance of the harness, particularly in suspension and work positioning. Preferably, the harness uses several pieces of webbing to form two shoulder straps, two identical leg straps, and a subpelvic strap. The variable-width webbing is preferably used to form the subpelvic strap.

### FIELD OF THE INVENTION

The present invention relates to a primary component of a personal fall arrest system, namely, the harness. The harness, often called a full body harness, is designed to safely support a person being lifted or lowered as well as to sufficiently distribute the fall arrest forces across the wearer's body during a fall, thereby reducing injury from the fall if the harness is properly used as part of a fall arrest system.

### BACKGROUND OF THE INVENTION

Full body harnesses are widely used for lifting and lowering individuals in dangerous situations and as a primary component in a personal fall arrest system. They can also be used for work positioning, travel restriction, ladder climbing, rescue retrieval and evacuation. While these harnesses are used mainly in an industrial setting, and particularly the construction industry where the likelihood and danger of falls from heights is both numerous and significant, a full body harness can be used in various other applications in which total suspension and support of the body must be ensured, either expectedly or unexpectedly.

Various full body harnesses are shown on pages 6-19 of the MSA Fall Protection Catalog [Vol. 4-2001/2002], including the FP Pro™ Harness, FP Trades™ Harness, FP Rescue™ Harness and FP Classic™ Harness. Such harnesses typically include a seat strap (also called a subpelvic strap), two leg straps and two adjustable shoulder straps which can be guided, typically in a crossed fashion, through a generally rectangular shaped pad formed on a rear part of the harness which is worn on a person's back and is often called a back pad. Generally, the entire harness is made from several pieces of straight webbing having a uniform width.

In the FP Pro Harness, as described in U.S. Pat. No. 5,957,091, the shoulder straps made from straight webbing continue forwardly over the shoulders and adjustably attach to each other via a pair of metal hip plates. Two leg straps are also adjustably attached to the hip plates and wrap around the legs of the wearer. The leg straps are also made from lengths of straight webbing. The width of this webbing is uniform and is typically 1.75 inches.

The FP Classic™ Pullover® Harness is more particularly shown and described in U.S. Pat. No. 4,712,513. This harness does not require the pre-adjustment of numerous elements to a particular individual but can be adjusted simply and quickly with a single adjustment for practically all sizes of individuals for whom the harness is intended. It also uses only pieces of straight webbing having a uniform thickness.

While all of the above-mentioned harnesses meet the applicable safety requirements, it would be desirable to improve their comfort in suspension and work positioning without reducing the performance characteristics, quality and versatility of these harnesses. In suspension and work positioning situations, the typical harness webbing width of 1.75 inches is too narrow for a worker to comfortably sit in a harness for a long period of time. A more optimum width would be in the range of 2.5 inches to 3.5 inches and preferably, 2⅝ inches to 3.0 inches. On a typical seat strap of a harness, a strap width of 2⅝ inches would provide 50% more surface area than a strap width of 1.75 inches. The wider webbing is more comfortable because it distributes the user's body weight over a larger area thereby reducing the pressure on the person's body. It also distributes the fall arrest forces more evenly.

Currently, there are several methods of spreading force over a larger area in harnesses. One method is to take two pieces of 1.75 inch webbing and layer and then sew or glue them together with the layers slightly offset. Another method is to take wide webbing and fold over the sides. This allows the webbing to be wide where it supports the body and narrow where it goes into the buckles and adjusters. The disadvantage with both of these methods is that they require additional sewing which increases the cost of the harness. They also do not perform as well in correctly distributing the forces under load or fall arrest conditions.

It would be desirable, therefore, to have a harness which provided improved comfort without having the drawbacks of the present methods.

### SUMMARY OF THE INVENTION

Generally, the present invention is a full body harness which utilizes individual lengths or pieces of variable-width webbing. Preferably, the harness comprises: a pair of shoulder straps (preferably adjustable); a subpelvic or seat strap comprising a single length of variable-width webbing; a pair of leg straps (preferably adjustable); a back pad; a shoulder strap retainer (preferably a front pad or a chest strap); and a pair of leg buckles. While the unitary piece of variable-width webbing is preferably utilized in the subpelvic or seat strap, such pieces could also be utilized in other parts of the harness such as the leg straps or the shoulder straps.

The present invention provides a unique, versatile and lightweight full body harness which still meets or exceeds most applicable requirements, including ANSI Z359.1, ANSI A10.14, CSA Z359.10 and OSHA, while improving its comfort, particularly during suspension and work positioning. The full body harness of the present invention is uniquely designed to contain the torso of a wearer, position it in an upright position and distribute fall arrest forces to the thighs, chest and shoulders of the wearer in the event of a fall. The harness of the present invention is intended to be used in personnel fall arrest systems as well as in work positioning. The harness preferably comes in the Pullover® model and the Vest-Type™ model with several sizes in each model, including extra small, standard, and extra large. Additionally, the full body harness of the present invention provides improved comfort, for example, by providing a subpelvic strap having a larger area while still utilizing the standard size buckles.

The full body harness of the present invention preferably utilizes five pieces of webbing, namely, two shoulder straps, two leg straps and a subpelvic strap. Preferably, the subpelvic strap of the harness comprises a unitary length of variable-width webbing. Preferably, each piece of variable-width webbing is narrower at its ends and wider in the middle.

The variable-width webbing used in the harness of the present invention is made from a single piece of woven material constructed in a repeating pattern of wide sections and narrow sections. The webbing is then cut in the middle of the narrow sections to form the subpelvic strap. Alternatively, the webbing could be made in different patterns which would result in pieces which could be used as shoulder straps and/or leg straps.

Other details and advantages of the present invention will become apparent as the following description of the invention proceeds.

### BRIEF DESCRIPTION OF THE DRAWINGS

In the accompanying drawings, preferred embodiments of the present invention and preferred methods of practicing the present invention are illustrated in which:

FIG. 1 is a front view of one embodiment of the full body harness of the present invention as it would be worn by a user;

FIG. 2 is a side view of the full body harness shown in FIG. 1;

FIG. 3 is a front view of another embodiment of the full body harness of the present invention as it would be worn by a user;

FIG. 4 is a side view of the full body harness shown in FIG. 3;

FIG. 5 shows a section of variable-width webbing used in a harness of the present invention;

FIG. 6 shows a normal reed; and

FIG. 7 shows a fan reed.

### PRESENTLY PREFERRED EMBODIMENT

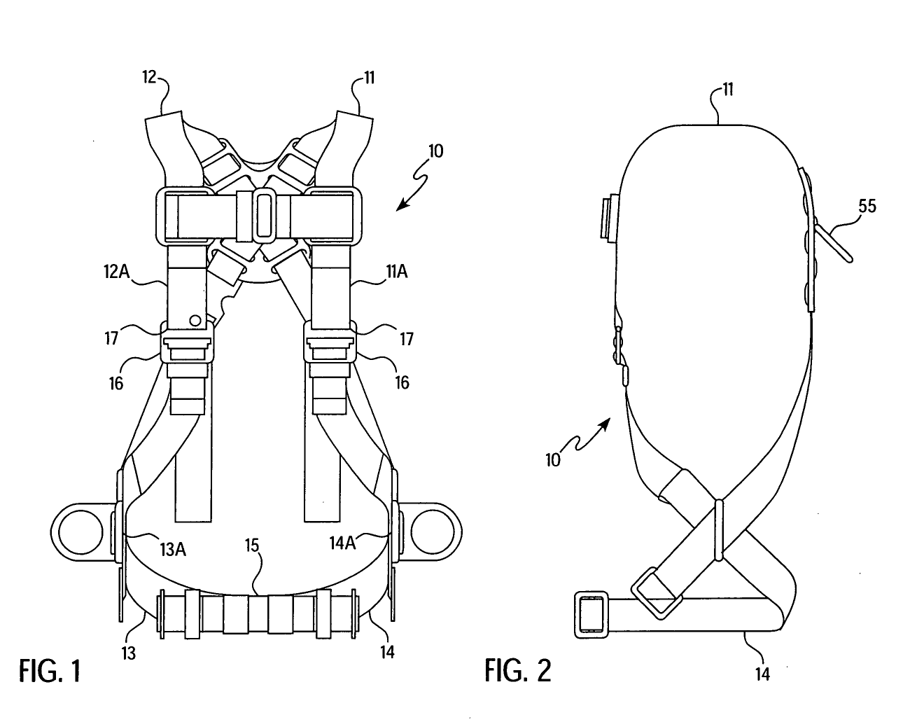

FIGS. 1-2 show a Vest-Type™ version of harness 10 of the present invention. Preferably, there are two curved shoulder straps 11,12 (preferably mirror images of each other), two leg straps 13,14 (preferably identical), and a variable-width subpelvic strap 15. Each shoulder strap 11(12) is attached at one end 11A(12A) to an adjustment mechanism 16. Preferably, this attachment is a permanent connection made by passing end 11A(12A) of shoulder strap 11 (12) through a first slot 17 in adjustment mechanism 16, and sewing the end to the shoulder strap 11A(12A) to form a closed loop. Leg strap 13 (14) is attached at one point 13A (14A) to shoulder strap 11 (12). Preferably that attachment is a permanent connection made by sewing.

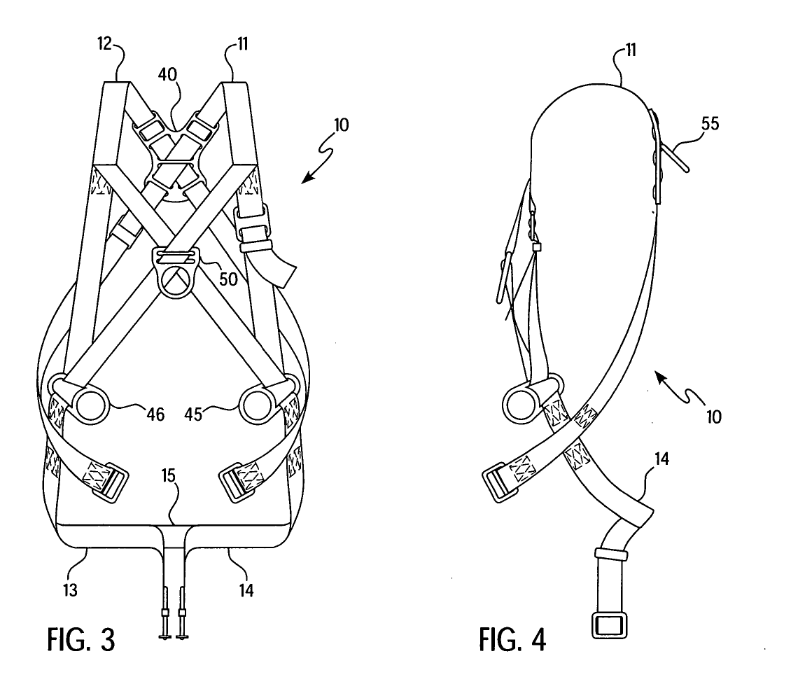

FIGS. 3-4 show a Pullover® version of the harness 10 of the present invention. This version is very similar to the one shown in FIGS. 1-2, except that shoulder strap 11(12) proceeds upwardly across the wearer's back and through the spreading back pad 40 (preferably in a crossed manner) forwardly over the wearer's shoulders and then straight down over the wearer's chest to a loop 45(46) on the wearer's hip, then back up across the wearer's chest through front pad 50 to end and be attached to the other shoulder strap 12(11).

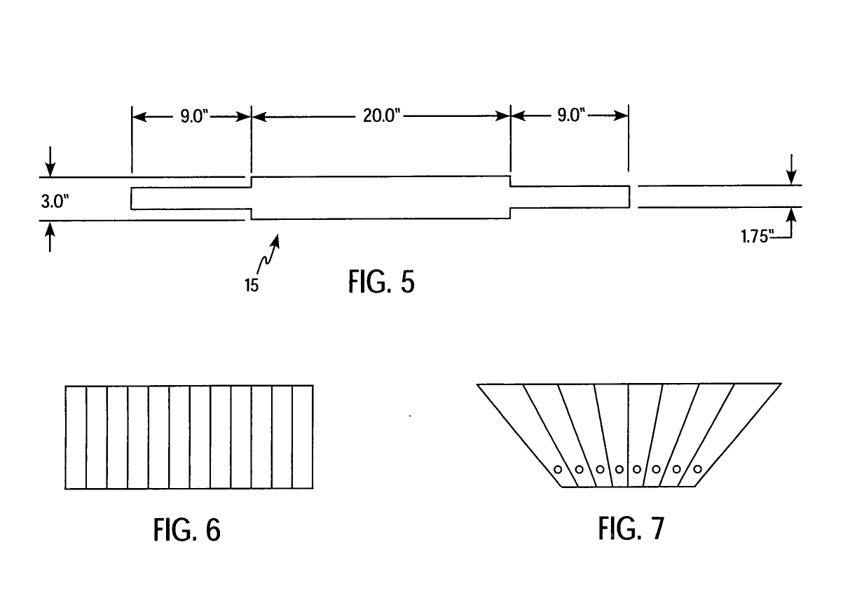

FIG. 5 shows a preferred embodiment of a single piece of unitary variable-width webbing that is used to form the subpelvic strap 15 of the present invention. Preferably, the variable-width webbing has a width of about 1.75 inches at its ends and about 3.0 inches in the middle. The wider middle section is preferably about 20 inches in length and the narrower end sections are each about 9 inches in length. Although the webbing is preferably made of a polyester material, other materials, such as nylon and Kevlar, will work.

While not known to be available on any standard looms, the present inventors have discovered that a loom can be modified to weave a variable width webbing fabric by using a “fan reed” that can be moved up or down depending on the width of fabric desired during weaving. A fan reed is shown in FIG. 7 and is commonly used in the preparation of warps to control the width of the warp sheet when making the warp. A “normal reed” is shown in FIG. 6.

When weaving, a reed serves two purposes. First, depending on the reed number and warp ends per dent (space), it will establish the ends per inch in the loom and the finished fabric. Second, once the filling yarn (pick) is inserted, the reed will beat in the pick to the fell of the cloth (that is the point where warp yarn becomes woven fabric). On ordinary looms, the reed wires of the reed are all oriented vertically and parallel to each other. With a fan reed as shown in FIG. 7, the reed wires are not parallel to each other. In the fan reed, when the reed is positioned so the warp yarns are in the lower position of the reed, the woven fabric will be narrower in width than if the reed is positioned vertically so that the warp yarns are in the upper part of the fan reed in reference to the warp line.

The design of the fan reed should be such that 28 dents (spaces) are spread over the 1.75 inches of width near the bottom of the reed and the same 28 dents are spread over 3 inches near the top of the reed. The vertical height of the usable part of the reed should be about 5 inches and the mechanism designed for moving the reed up and down on the lay of the loom should also be about 5 inches. There are many other reed constructions and ends per dent that can be used to accomplish the desired results, such other fan reed construction or selection can easily be determined by those skilled in the art. Fan reeds can be purchased from Steel Heddle Mfg. Co. of Greenville, S.C.

It will also be necessary to modify the “lay” of the loom so that the fan reed can be moved up and down to control the woven fabric width. The position of the fan reed, up or down, should be controlled either mechanically or with some form of a stepper motor that gets its impulse from the harness chain (head motion) on the loom. A cam loom would be unsatisfactory and one must resort to either a dobby or Jacquard-type of head motion for this purpose. Thus, the dobby or Jacquard would be programmed to operate the mechanical raising and lowering of the fan reed in increments as the weaving of the variable-width webbing progresses.

Preferably, the type of loom to convert for this purpose would be a shuttle-type, narrow fabric loom. With a shuttle-type loom, it does not matter if the shuttle is weaving a narrow fabric or a wide fabric. In either case, the filling will be inserted into the fabric at the width of the warp in the reed so long as the filling is caught by some crossing warp yearns near the selvage edge of the fabric. In addition, no other unusual moving parts would be necessary to weave the unitary variable-width webbing of the present invention. However, a narrow fabric shuttle-type loom is slow in production with an insertion rate of filling yarn of only about 125 picks-per-minute. On the other hand, a needle loom can weave at over 1500 double picks-per-minute. The needle loom uses a curved needle to insert the double pick in each shed and a latch needle must be incorporated to catch the filling yarn and prevent it from pulling into or back out of the shed. To operate properly, the catch latch needle must be positioned at the right position at the edge of the fabric. To weave a variable-width webbing with this loom, as the woven fabric varies in width, the latch needle must also move left and right as the fabric changes in width. In addition to developing the mechanical component to do this, the movement should also be controlled by the head motion of the loom. As before, this would require either a dobby or a Jacquard head motion to do this.

Although the present invention has been described in detail above for the purpose of illustration, it is to be understood that such detail is solely for that purpose and that variations can be made therein by those of ordinary skill in the art without departing from the spirit and scope of the invention as defined by the following claims including all equivalents thereof.

What is claimed is:

1. A body harness comprising: a pair of shoulder straps; a pair of leg straps; and a subpelvic strap, wherein the subpelvic strap comprises a single length of webbing, woven with a variable width along its length.

2. The body harness of claim 1 wherein at least one shoulder strap comprises webbing, woven with a variable width along its length.

3. The body harness of claim 1 wherein at least one leg strap comprises webbing, woven with a variable width along its length.

4. A body harness utilizing at least one piece of webbing, woven with a variable width along its length.

5. The body harness of claim 4 wherein a subpelvic strap comprises a piece of webbing, woven with a variable width along its length.

6. The body harness of claim 4 wherein at least one shoulder strap comprises webbing, woven with a variable width along its length.

7. The body harness of claim 4 wherein at least one leg strap comprises webbing, woven with a variable width along its length.
